(19) United States
(12) Patent Application Publication
(10) Pub. No.: US 2007/0183444 A1
(43) Pub. Date: Aug. 9, 2007

(54) SYSTEMS AND METHODS FOR PROVIDING AND MANAGING HIGH-AVAILABILITY POWER INFRASTRUCTURES WITH FLEXIBLE LOAD PRIORITIZATION

(75) Inventor: Roland Schoettle, American Canyon, CA (US)

Correspondence Address: FULBRIGHT & JAWORSKI L.L.P, 2200 ROSS AVENUE, SUITE 2800, DALLAS, TX, 75201-2784, US

(73) Assignee: Optimal Licensing Corporation, Freeport (BS)

(21) Appl. No.: 11/671,261

(22) Filed: Feb. 5, 2007

Related U.S. Application Data
(60) Provisional application No. 60/765,770, filed on Feb. 6, 2006.

(51) Int. Cl. H04L 12/403

(52) U.S. Cl. 370/449

(57) ABSTRACT

Systems and methods for providing and managing high-availability power infrastructures with flexible load prioritization are described. In one embodiment, a system comprises a switch control and monitoring center that monitors and controls a distributed array of remotely controllable switches to optimize power distribution in a high-availability infrastructure according to priority levels. The high-availability comprises an electric battery storage and/or auxiliary generation equipment. In another embodiment a software package performs power quality analysis, ranking, and optimization, thus enabling the assessment of overall local and grid power demand trends. Load priority adjustments may be made in real-time.

### CROSS-REFERENCE TO RELATED APPLICATIONS

This application claims priority benefit of U.S. Provisional Application Ser. No. 60/765,770 entitled “DISTRIBUTED SYSTEM AND METHOD FOR MANAGING LOADS TO MEET ELECTRIC POWER AVAILABILITY AND POWER QUALITY,” filed Feb. 6, 2006, the disclosure of which is hereby incorporated by reference herein.

### TECHNICAL FIELD

The present invention relates, in general, to electrical power systems and, more specifically, to systems and methods for providing and managing high-availability power infrastructures with flexible load prioritization.

### BACKGROUND

In recent years, the electric power industry has been burdened by an accelerated increase in demand that threatens the integrity of high-scale generation and transmission systems. As a consequence, customers often experience problems of restricted capacity (“brownouts”) and service interruptions (“blackouts”).

Even when operating under normal, non-peak conditions, modern power systems deliver services with only 99.9% of reliability, which represents an outage equivalent to about nine hours per year for a typical customer. This level of service is clearly inadequate in the information age, and represents a significant threat to data-processing centers, call centers, telecommunication switching facilities, emergency services, hospitals, and other critical applications. For example, where power is provided at 60 cycles per second, a two-cycle “hiccup” can frequently cause most computers and servers to reboot or lock-up.

Without immediate and adequate power for computers, communication systems, defense and security systems, appropriate response to terrorist attacks and natural catastrophes can be very difficult. Before the attacks of Sep. 11, 2001, concerns about power interruption focused primarily on the risk of equipment failures, extreme weather conditions, and accidents. Since then, however, there has been a growing concern regarding the possibility of deliberate attacks on the electric power system. Other recent events have further stressed the importance of securing our power supply systems.

It is generally accepted that satisfactory levels of electrical power services must be provided with at least 99.9999% of availability, or the equivalent of 32 seconds of outages per year. Unfortunately, it has become increasingly difficult for utilities to reach these relatively high levels, particularly due to the fact that power quality is adversely affected as loads increase. It will be virtually impossible to attain the desired degree of availability from current utility transmission and distribution power infrastructures in the foreseeable future.

A typical solution to these problems involves the local deployment of a distributed generation unit (“DG”) or battery operated, uninterruptible power supply (“UPS”) system. Because information, security, defense, and communications systems are often widely dispersed within a single premises, one of two approaches is commonly followed. First, a large DG and UPS unit may be deployed in order to fulfill the electrical loads of an entire building. Alternatively, a plurality of DG or UPS systems may be installed in different parts of the building, each unit thus servicing a particular portion thereof.

The deployment of DG or UPS systems often presents itself as a business decision. Customers adopting these solutions are, in fact, generating power on-site in lieu of purchasing power from the local utility and risking production shutdown because of poor power quality. Unfortunately, for many customers, purchasing a local power supply system that supports all building load or a widely dispersed collection of critical load is far too expensive.

Prior art system 100 shown in FIG. 1 attempts to reduce emergency power and local generation costs in situations involving high-priority loads. Particularly, utility power line 101 provides power to a customer via a regular infrastructure line 102, and is also connected to UPS 103. UPS 103 receives “regular” power from utility power line 101 and provides a reliable, high-availability power source via high-priority infrastructure 104. Accordingly, the customer may choose to connect low-priority or “regular” loads (not shown) to regular priority line 102, and high-priority devices or loads 105-107 to high-availability infrastructure 104.

As illustrated in FIG. 1, prior art systems use one power distribution system for high-priority loads and another for regular loads. Equipment connected to high-availability distribution lines enjoy more reliable performance than equipment connected o regular lines because they are supported by a UPS or DG system. Nonetheless, high priority loads, regardless of their location, are supported by a redundant distribution infrastructure

### SUMMARY OF THE INVENTION

The present invention provides an electrical power infrastructure cap able of controlling the availability and distribution of power to power lines and devices connected thereto according to a priority system. In one exemplary embodiment, a high-availability “backbone” power line or circuit provided by a high-availability power supply unit (e.g., UPS, DG, etc.) selectively feeds power to one or more flexible priority power lines (collectively referred to as “sub power lines”). Each flexible priority line may serve a single device, a plurality of devices, or an entire site. Remotely controllable switches or power control devices connect the backbone line to one or more flexible priority lines. For example, under normal operating conditions, a switch may be closed and thus provide high-availability power to its respective flexible priority line. Upon the happening of a specific event, a controller may transmit a signal to the switch that opens the circuit and cuts off high-availability power to its flexible priority line.

In one embodiment of the present invention, each switch may be ranked as to its relative priority depending upon the available power, interaction with other switches, and/or relative importance of the devices connected thereto (e.g., security, communications, safety, protection, etc.). Each switch may provide information as to all sources and loads, and may also provide dynamic “islanding” or the creation of intelligent, interactive “microgrids” within a building or region. Switches may be remotely operated by a single programmable controller such as a computer, for instance, via a communications network. In one alternative embodiment, a controllable switch may be embedded directly into devices that connect directly to the backbone power line.

The foregoing has outlined rather broadly certain features and technical advantages of the present invention so that the detailed description that follows may be better understood. Additional features and advantages are described hereinafter. As a person of ordinary skill in the art will readily recognize in light of this disclosure, specific embodiments disclosed herein may be utilized as a basis for modifying or designing other structures for carrying out the same purposes of the present invention. Such equivalent constructions do not depart from the spirit and scope of the invention as set forth in the appended claims. Several inventive features described herein will be better understood from the following description when considered in connection with the accompanying figures. It is to be expressly understood, however, the figures are provided for the purpose of illustration and description only, and are not intended to limit the present invention.

### BRIEF DESCRIPTION OF THE DRAWINGS

For a more complete understanding of the present invention, reference is now made to the following drawings, in which:

FIG. 1 shows a block diagram of a prior art power distribution system;

FIG. 2 shows a block diagram of a system for providing and managing a high-availability power infrastructure with flexible load prioritization according to an embodiment of the present invention;

FIG. 3 shows a circuit diagram of a remotely controllable switch with fault protection according to an embodiment of the present invention;

FIG. 4 shows a circuit diagram of a remotely controllable switch with fault protection and a controllable override circuit according to an embodiment of the present invention; and

FIG. 5 shows a block diagram of a programmable computer adapted to implement an embodiment of the present invention.

### DETAILED DESCRIPTION

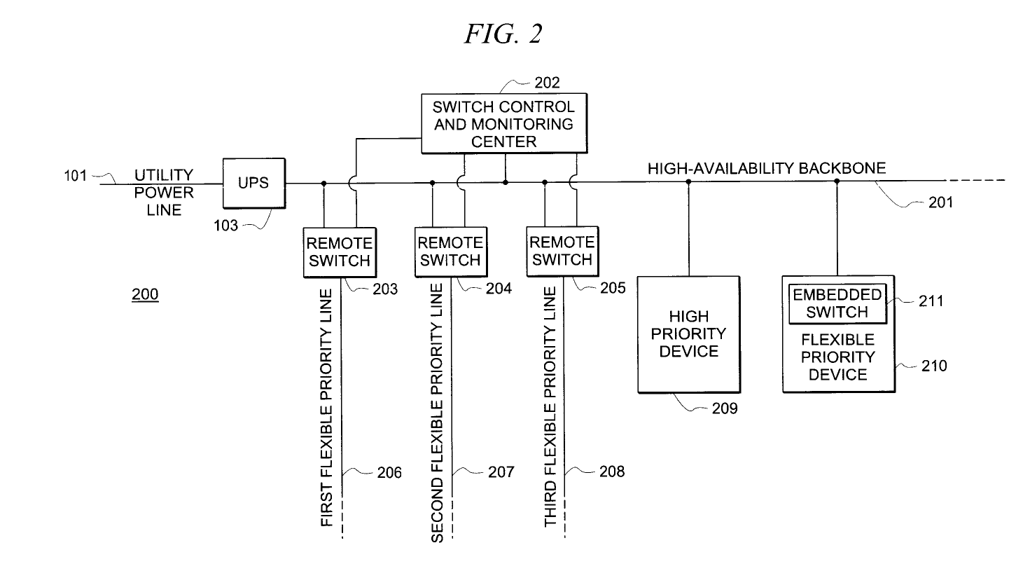

FIG. 2 shows a block diagram of system 200 for providing and managing a high-availability power infrastructure with flexible load prioritization according to an exemplary embodiment of the present invention. Utility power line 101 provides power to UPS 103. As such, UPS 103 receives “regular” power from utility power line 101 and provides a reliable, high-availability power source via high-availability backbone line 201. In alternative embodiments, any power source (e.g., a DG unit) may be used instead of, or in addition to, UPS 103. A plurality of flexible-priority branches or lines 206-208 are connected to backbone line 201 via remotely controllable switches 203-205. Switch control and monitoring center 202 is connected to each of switches 203-205, either by direct wiring, wirelessly, or by signals communicated via the power grid. Furthermore, switch control and monitoring center 202 may receive power necessary for its own operation from backbone line 201.

In one exemplary embodiment, remotely controllable switches 203-205 remain closed under normal operating conditions, thus allowing electrical current to flow from backbone line 201 to flexible priority lines 206-208. Each flexible priority line may have a priority level associated therewith. For example, different priority profiles may be programmed into, or associated with, each of switches 203-205. As such, when one of switches 206-208 receives a signal from switch control and monitoring center 202 that has a priority profile that is higher than the switch's priority profile, the switch opens and cuts off high-availability power to its respective flexible priority line. In these cases, each of flexible-priority lines 206-207 may be backed up by utility power line 101 to provide regular power to lower priority loads connected thereto. Additionally or alternatively, system 200 may be designed to respond to diminished DG or UPS 103 output when, for example, fuel supply or battery reserves reach a critical level.

Even though switches 203-205 have been shown as on/off switches, they alternatively be controllable power limiting devices such as, for example, variable current limiters, or the like. When power control devices are used in place of switches 203-205, system 200 is capable of controlling the maximum consumption of power distributed to each flexible priority line. Therefore, rather than turning low priority lines completely off, system 200 can allocate varying amounts of power to each line (or device) as a function of, or in proportion to, their respective priority profiles.

The term “high or higher priority load or device” is used throughout this disclosure to identify loads that must preferably be supplied electrical power to the detriment of “low or lower priority loads or devices” (when necessary), due to the relative importance of their operation. As shown in FIG. 2, high priority device 209 is directly connected to backbone line 201. Lower priority devices (not shown) may be connected to one of flexible priority lines 206-208, depending on their level of importance. In the exemplary embodiment of system 200, first flexible-priority line 206 has a higher priority than second flexible-priority line 207, and second flexible-priority line 207 has a higher priority than third flexible-priority line 205.

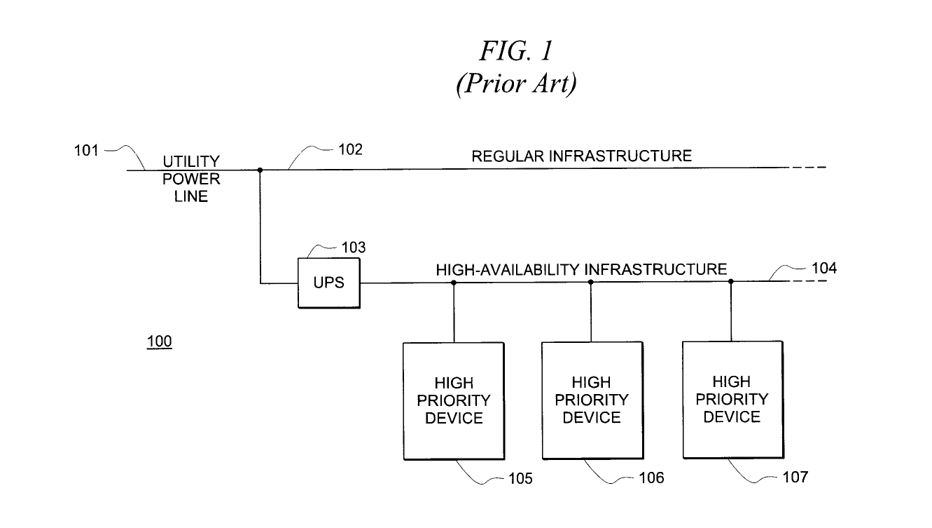

Still referring to FIG. 2, second priority device 210 is connected to backbone line 201 via internal switch 211, thus making its access to backbone line 201 controllable via switch control and monitoring center 202. In this case, internal switch 211 may be embedded into the power input circuitry of device 210 and operable to communicate with switch control and monitoring center 202 wirelessly or via the power line. As will be readily recognized by a person of ordinary skill in the art in light of this disclosure, system 200 may be added to an existing infrastructure such as the one depicted in FIG. 1, in order to advantageously provide the flexible prioritization of loads and other advantages described herein.

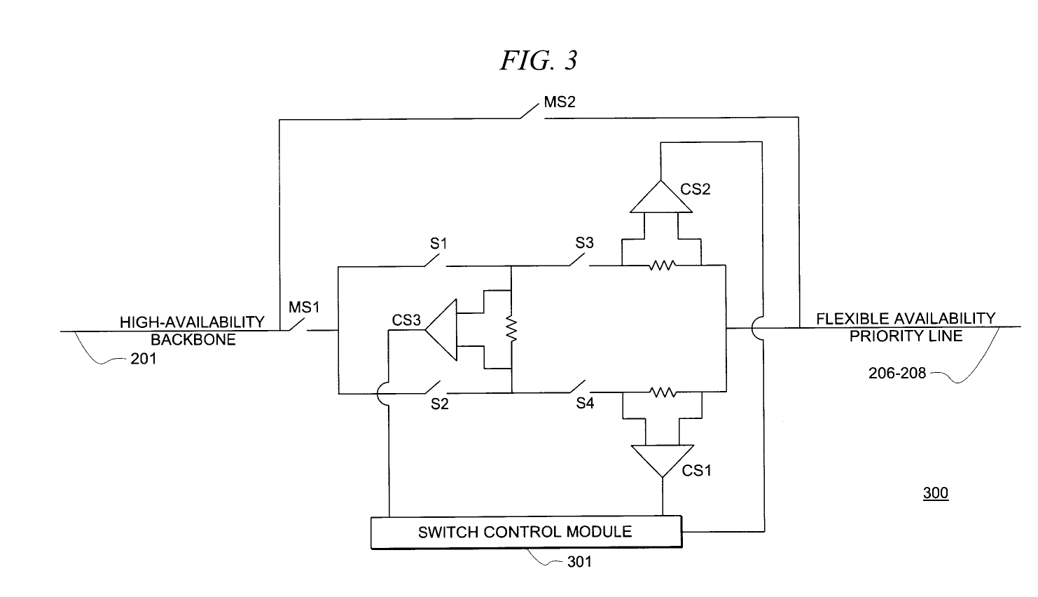

Turning now to FIG. 3, circuit diagram 300 of a remotely controllable switch with fault protection is depicted according to an exemplary embodiment of the present invention. In this embodiment, switch 300 may be used as any of switches 203-205 and/or 211 shown in FIG. 2, and is operable to connect backbone line 201 to flexible-priority lines 206-208 and/or device 210. Exemplary switch 300 comprises four toggle switches (S1-S4), two master switches (MS1 and MS2), and three current sensors (CS1-CS3). Switch 300 also comprises switch control module 301. Switch control module 301 may comprise a communications unit (not shown) for exchanging signals with switch control and monitoring center 202 and a controller (not shown) for controlling the operation of toggle switches S1-S4.

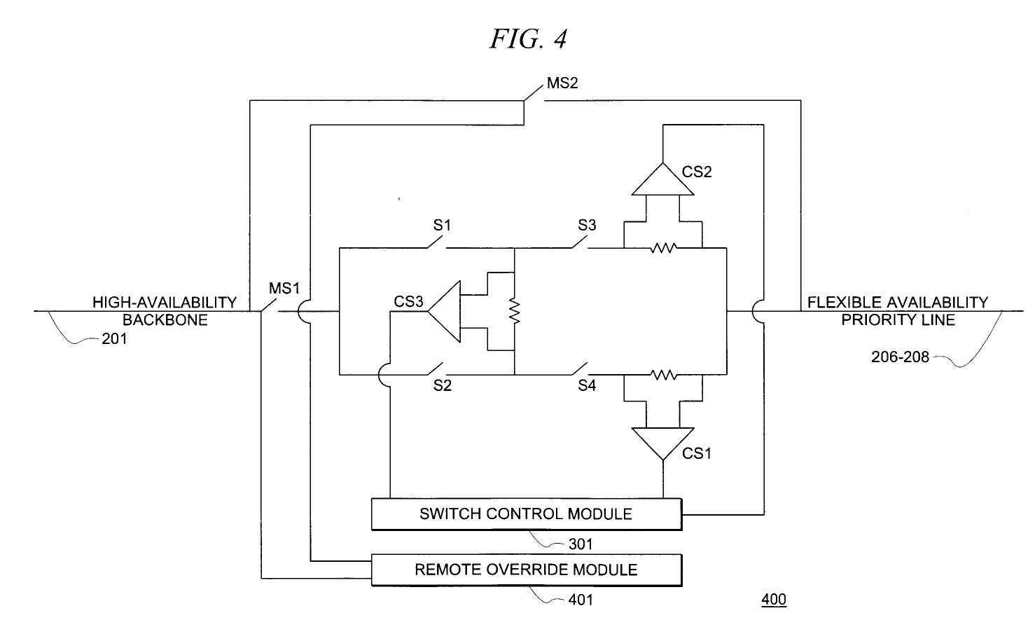

In operation, switches S1-S4 maintain identical status (i.e., they are either all open or all closed). The status of switches S1-S4 is controlled by switch control module 301. Master switches MS1 and MS2 may be used for performance and reliability testing and provide normal condition override functionality by forcing switch 300 to be either open or closed regardless of the status of toggle switches S1-S4. In the embodiment shown in FIG. 3, master switches MS1 and MS2 are manually operated. FIG. 4 shows alternative circuit 400 having remote override module 401 for remotely controlling master switches MS1 and MS2. In an alternative embodiment (not shown), the functionality of remote override module 401 may be built into switch control module 301.

Table I depicted below shows the overall functionality of switches 300 and/or 400 under a variety of S1-S4 switch faults:

TABLE I
Overall Functionality

| Functionality | Faults | Functionality | Faults |
|---|---|---|---|
| Closed | S1 | Open | S1 |
| | S2 | | S2 |
| | S3 | | S3 |
| | S4 | | S4 |
| | S1 and S4 | | S1 and S2 |
| | S1 and S3 | | S4 and S3 |
| | S2 and S3 | | — |
| | S2 and S4 | | — |

The embodiments described above with respect to FIGS. 3 and 4 allow the testing of toggle switches S1-S4's functionality during service, in addition to providing redundant failure protection. The in-service testing may be scheduled in advance. For example, switch control and monitoring center 202 may send an “open S4” command to switch control center 301 for toggling switch S1. If S1 opens on command, current sensor CS3 reports a current increase to switch control center 301, which in turn sends a response message to switch control and monitoring center 202. Current sensors CS1-CS3 may also report energy usage and other parameters to switch control and monitoring center 202 for energy management or any other purposes.

Table II depicted below shows current sensor (CS1-CS3) status as a function of toggle switch (S1-S4) status:

TABLE II
Current Sensor Status as a Function of Toggle Switch Status

| Toggle Switch Position | | | | Current Sensor Indicator | | |
|---|---|---|---|---|---|---|
| S1 | S2 | S3 | S4 | CS1 | CS2 | CS3 |
| Closed | Closed | Closed | Closed | Middle | Middle | Low |
| Open | Closed | Closed | Closed | Middle | Middle | Middle |
| Closed | Open | Closed | Closed | Middle | Middle | Middle |
| Closed | Closed | Open | Closed | High | 0 | Middle |
| Closed | Closed | Closed | Open | 0 | High | Middle |
| Open | Open | Closed | Closed | 0 | 0 | 0 |
| Open | Closed | Open | Closed | High | 0 | 0 |
| Open | Closed | Closed | Open | 0 | High | High |
| Closed | Open | Open | Closed | High | 0 | High |
| Closed | Open | Closed | Open | 0 | High | 0 |
| Open | Open | Open | Closed | 0 | 0 | 0 |
| Open | Open | Open | Open | 0 | 0 | 0 |

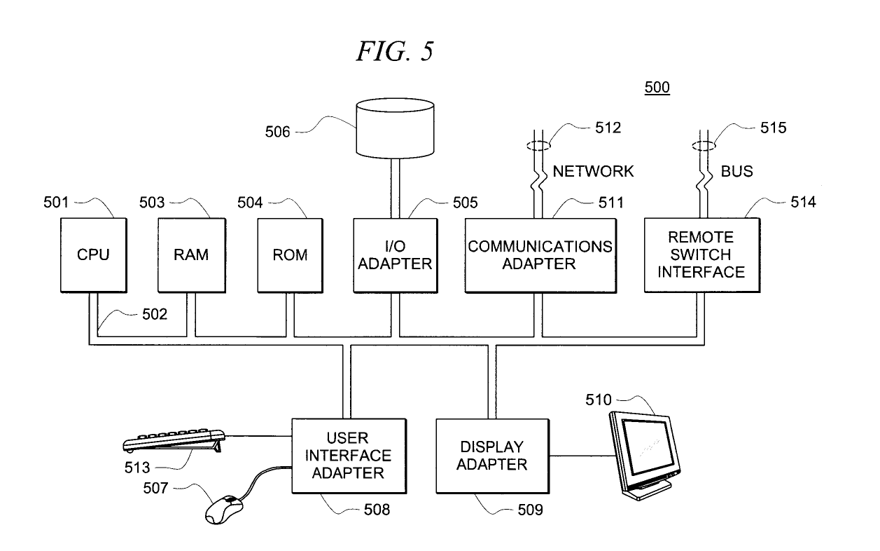

Turning now to FIG. 5, a block diagram of programmable computer 500 adapted to implement switch control and monitoring center 202 of FIG. 2 is depicted according to an embodiment of the present invention. Central processing unit (“CPU”) 501 is coupled to system bus 502. CPU 501 may be any general purpose CPU. However, the embodiments of the present invention are not restricted by the architecture of CPU 501 as long as CPU 501 supports the inventive operations as described herein. Bus 502 is coupled to random access memory (“RAM”) 503, which may be SRAM, DRAM, or SDRAM. ROM 504 is also coupled to bus 502, which may be PROM, EPROM, or EEPROM.

Bus 502 is also coupled to input/output (“I/O”) controller card 505, communications adapter card 511, user interface card 508, and display card 509. I/O adapter card 505 connects storage devices 506, such as one or more of a hard drive, a CD drive, a floppy disk drive, a tape drive, to computer system 500. I/O adapter 505 is also connected to a printer (not shown), which would allow the system to print paper copies of information such as documents, photographs, articles, and the like. The printer may be a printer (e.g., dot matrix, laser, and the like), a fax machine, scanner, or a copier machine. Communications card 511 is adapted to couple the computer system 500 to network 512, which may be one or more of a telephone network, a local (“LAN”) and/or a wide-area (“WAN”) network, an Ethernet network, and/or the Internet. User interface card 508 couples user input devices, such as keyboard 513, pointing device 507, and the like, to computer system 500. Display card 509 is driven by CPU 501 to control the display on display device 510.

In one embodiment, computer 500 sends instructions to switches 203-205 using communications adapter 511 via network 512. Alternatively, computer 500 may comprise remote switch interface 514 operable to exchange messages, signals, or instructions with remote switches 203-205 and/or 211 shown in FIG. 2 via bus 515. Bus 515 may comprise any medium, such as, for instance, a power line (e.g., backbone 201), an optical fiber, a wireless medium (i.e., air), any other medium (e.g., twisted pair, coaxial cable, etc.). Remote switch interface 514 may comprise, for instance, a data acquisition card having input and output (analog or digital) channels capable of communicating with switch control modules 301 and/or 401.

In operation, computer 500 communicates with each of remotely controllable switches 203-205 and/or 211 individually or in groups. Command messages are sent from computer 500 to open or close remotely controllable switches based on their priority profiles. In one non-limiting example, a “priority 3” command opens all switches with a priority profile of 3 or lower (i.e., “priority 3,” “priority 4,” “priority 5,” etc.) without affecting the operation of switches with a higher priority profile (i.e., “priority 1” and “priority 2”). If, for any reason, any of remotely controlled switches 203-205 does not correctly respond to a command from computer 500, the faulty switch reports the problem to computer 500 via bus 515 (or network 512).

In one embodiment of the present invention, computer 500 executes software that allows users to monitor and manage the high-availability infrastructure. For instance, the software may have a graphical user interface (GUI) that presents a block diagram of the infrastructure, such as the one shown in FIG. 2. The user may assign priority profiles to each switch of the infrastructure using the GUI. The software may also provide alerts and reports periodically, upon request, or when a critical condition is reached (e.g., faulty switch is detected).

A user may assign priority profiles to each of switches 203-205 and/or 211, for example, in order to fulfill optimization objectives such as maximizing run times, available DG fuel supply, UPS battery reserves, peak load mitigation for overall improved electric load management, or the like. The user may also use a set of operations defined in natural language to manage and control switches 203-205 and/or 211 according to its individual requirements and priorities.

In one exemplary embodiment, the following set of operations is provided: (a) never turn off; (b) turn off instantly after utility power supply is lost; (c) turn off n seconds after utility power supply is lost; (d) never turn on equipment that is being threatened by utility power quality or power loss (imminent utility brownout or blackout); (e) turn off when the unit price of power exceeds a given amount; (f) turn off on utility demand response signal; (g) and change (reset) remote switch priority on ranked optimization signal(s) including fuel availability, occupancy levels, security threats, communication requirements, etc.

Using the aforementioned exemplary operators, priority profiles may be assigned to each switch, for instance, on a scale of 1 to 5. For example, a switch may be assigned a “priority level 1” when the user desires it to never be turned off. The user may assign a “priority level 2” to switches that cannot turn on equipment threatened by utility power quality or power loss. Another switch may be assigned a “priority level 3” when the user wants to turn it off 2 minutes after power supply is lost or when the unit price of power exceeds a preset limit, such as $200.00. Another switch may be assigned a “priority level 4” when the user wants to turn it off 30 seconds after power supply is lost or when the unit price of power exceeds $100.00. The user may assign a “priority level 5” to switches that should turn off instantly after power supply is lost or when the unit price of power exceeds $50.00.

The user may arbitrarily assign priority levels to each switch or group of switches. Further, the user may create, modify, or define the operations upon which the priority levels may be based. Additionally or alternatively, switch control and monitoring center 202 may be programmed to fulfill optimization by monitoring the operating conditions of switches 203-205 and/or 211 by adjusting their priority profiles without further user input.

The functions and/or algorithms described above may be implemented for example, in software or as a combination of software and human procedures. Software may comprise computer executable instructions stored on a computer readable medium such as memory or other type of storage device. Further, functions may correspond to modules, which may be software, hardware, firmware or any combination thereof. Multiple functions may be performed in one or more modules as desired, and the embodiments described are merely examples. Software may be executed on a digital signal processor, microprocessor ASIC, or other type of processor or controller.

Particularly in view of the foregoing, a person of ordinary skill in the art will readily recognize that the present invention provides numerous advantages over the prior art. For instance, a prior art system such as the one shown in FIG. 1 requires two expensive separate power distribution lines. Also, designing two separate power distribution systems requires long term planning with little flexibility for future changes. Further, because regular distribution lines typically run together with high-priority lines, unsophisticated customers often overwhelm DG and UPS units by connecting regular loads to high-priority lines, thus reducing the quality of the high priority infrastructure. Conversely, high-priority loads may also inadvertently be connected to regular lines, thus putting important equipment at risk.

Meanwhile, the systems and methods of the present invention allow the provisioning of power using a flexible power priority principles that obviate the need for redundant power lines. The present invention also allows small, economical DG and UPS systems, to meet the exigent requirements of the information, security, defense, and telecommunications industries. In addition, the present invention successfully addresses the need for reliable power supply that is critical to public facilities during emergencies, avoids detrimental demand peaks that would otherwise lead to brownouts or service interruptions, lowers security risks involved in the operation of the electric power grid, improves grid reliability and efficiency, and reduces reliance on higher cost “must-run” generators. As will be readily recognized by a person of ordinary skill in the art in light of this disclosure, systems according to the present invention may also be advantageously adapted to fit existing infrastructures, thus allowing standard power lines to support a flexible, high-availability power infrastructure.

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods, and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods, or steps.

What is claimed is:

1. A system for managing a high-availability electrical power infrastructure, said system comprising:
at least one high-availability backbone power line for supplying power to a plurality of sub power lines; and
a switch associated with each said sub power line, each said switch operable to selectively remove said associated sub power line from said high-availability backbone power line as a function of a priority assigned to each said associated sub power line.

2. The system of claim 1 further comprising:
a monitoring center operable to communicate with each said switch to manage the provisioning of power from said high-availability backbone power line to each said sub power lines.

3. The system of claim 2 further comprising:
at least one power supply connected to a utility power line for creating said high-availability backbone power line.

4. The system of claim 3 wherein said power supply is selected from the group consisting of: a distributed generation unit and a power supply unit.

5. The system of claim 2 wherein said monitoring center orders said switch to decouple said associated sub power line from said high-availability backbone power line by issuing a command comprising a priority level.

6. The system of claim 5 wherein each said switch monitors loads connected to said associated sub power lines.

7. The system of claim 6 wherein each said switch transmits monitored data to said monitoring center.

8. The system of claim 7 wherein said monitoring center orders said switch to perform an in-service test.

9. A switch for use in a high-availability power system, said switch comprising:
a priority profile associated therewith, said switch operable to decouple a load from a backbone power line upon receipt of a priority command based upon the level of said switch priority profile.

10. The switch of claim 9 further comprising:
a load monitoring device for determining power consumption.

11. The switch of claim 10 further comprising:
a testing device for testing the operation of said switch.

12. The switch of claim 11 further comprising:
a communication device for transmitting monitored data to a monitoring center.

13. The switch of claim 12 wherein said switch decouples said load from a high-availability backbone power line when said priority command contains a priority level having a value higher than said switch priority profile.

14. A computer for monitoring a high-availability premises power grid, said computer comprising:
inputs for receiving parameter data from a plurality of sources; some of said sources being switches interposed on sub power lines connected to a backbone power line; each of said switches having a priority level for activation; and
a first set of routines, including computer executable instructions, for sending communications to said switches concerning priority levels.

15. The computer of claim 14 further comprising:
a second set of routines, including computer executable instructions, for optimizing power distribution in said power grid by controlling the operation of said switches.

16. A method for controlling the distribution of power among a plurality of devices connected to a power grid, said method comprising:
associating each of said plurality of devices with a priority profile; and
providing power to at least one of said devices as a function of said priority profile.

17. The method of claim 16 further comprising:
detecting a change in the availability of power in said power grid.

18. The method of claim 17 further comprising:
controlling the distribution of power to at least one of said plurality of devices as a function of said detected change in availability of power and said priority profiles.

19. A system for controlling the power consumption of devices connected to a plurality of sub power lines, each said sub power line receiving power from a high availability backbone, said system comprising:
means for controlling the availability of power to each said sub power line based at least in part upon a priority profile associated with each said sub power line.

20. The system of claim 19 further comprising:
means for detecting a change in the availability of power in said high-availability backbone; and
means for adjusting the availability of power in each said sub power line based at least in part upon said detected change.
